(19) United States
(12) Patent Application Publication
(10) Pub. No.: US 2024/0369454 A1
(43) Pub. Date: Nov. 7, 2024

(54) WHEEL STATE DETERMINATION APPARATUS

(71) Applicant: ISUZU MOTORS LIMITED, Tokyo (JP)

(72) Inventors: Takayuki MEGURO, Fujisawa-shi, Kanagawa (JP); Tatsuya NAGAOKA, Fujisawa-shi, Kanagawa (JP); Akira IMAI, Fujisawa-shi, Kanagawa (JP)

(21) Appl. No.: 18/689,970

(22) PCT Filed: Sep. 20, 2022
(86) PCT No.: PCT/JP2022/034933

§ 371 Date: Mar. 7, 2024

(30) Foreign Application Priority Data
Sep. 27, 2021 (JP) 2021-156423

(51) Int. Cl. G01M 17/013

(52) U.S. Cl. CPC G01M 17/013

(57) ABSTRACT

A wheel state determination apparatus includes: a first acceleration acquisition part that sequentially acquires axial accelerations in an axial direction of a wheel, the axial accelerations being detected at predetermined intervals by an acceleration sensor provided in the wheel of a vehicle, and a wheel separation determination part that determines that the possibility of the wheel coming off is high when the axial acceleration acquired by the first acceleration acquisition part is greater than a predetermined determination threshold value.

### TECHNICAL FIELD

The present invention relates to a wheel state determination apparatus.

### BACKGROUND OF THE INVENTION

Conventionally, a device that detects a state of a tire by monitoring air pressure of the tire with a pressure sensor provided in a wheel has been known (see Patent Document 1).

### PRIOR ART

### Patent Document

[Patent Document 1]: Japanese Unexamined Patent Application Publication No 2018-52355

### BRIEF DESCRIPTION OF THE INVENTION

### Problem to be Solved by the Invention

When a wheel is not appropriately fastened to an axle (for example, when a nut of a wheel member of the wheel is loosened), a wheel separation may occur while a vehicle is traveling. The technology of Patent Document 1 cannot appropriately detect that the wheel is in a state where it may come off.

The present invention focuses on this point, and its object is to detect that a wheel is in a state where it may come off.

### Means for Solving the Problem

One aspect of the present invention provides a wheel state determination apparatus including: an acceleration acquisition part that sequentially acquires axial accelerations in an axial direction of a wheel, the axial accelerations being detected at predetermined intervals by an acceleration sensor provided in the wheel of a vehicle; and a wheel separation determination part that determines that a possibility of the wheel coming off is high if the axial acceleration acquired by the acceleration acquisition part is greater than a predetermined determination threshold value.

The wheel separation determination part may determine that the possibility of the wheel coming off is high, if the number of times the acquired axial acceleration exceeds the determination threshold value reaches a predetermined number of times within a predetermined time.

The wheel state determination apparatus may further include: a road surface determination part that determines a road surface condition of a road surface on which the vehicle travels, wherein the wheel separation determination part may change the determination threshold value according to the road surface condition determined by the road surface determination part.

The acceleration acquisition part may further acquire circumferential acceleration in a circumferential direction of the wheel and radial acceleration in a radial direction of the wheel, and the road surface determination part may determine the road surface condition on the basis of the circumferential acceleration and the radial acceleration acquired by the acceleration acquisition part.

The road surface determination part may extract vertical oscillation pertaining to the road surface from the circumferential acceleration and the radial acceleration acquired by the acceleration acquisition part, and determine a type of the road surface on the basis of the vertical oscillation.

The road surface determination part may determine that the road surface is gravel if the magnitude of the vertical oscillation is greater than a predetermined value, and determine that the road surface is paved if the magnitude of the vertical oscillation is smaller than the predetermined value.

The wheel separation determination part may set, as the determination threshold value, a value obtained by multiplying a moving mean value of the axial accelerations by a predetermined coefficient. Further, the wheel separation determination part may set, as the determination threshold value, a value obtained by adding a moving standard deviation to a moving mean value of the axial accelerations.

The acceleration acquisition part may acquire the axial accelerations of each of a plurality of wheels of the vehicle, and the wheel separation determination part may determine that a possibility of the wheel coming off is high when axial acceleration of one wheel is outside a range indicated by a mean value of the axial accelerations of the plurality of wheels and a standard deviation.

### Effect of the Invention

According to the present invention, it is possible to detect that a wheel is in a state where it may come off.

### BRIEF DESCRIPTION OF THE DRAWINGS

FIG. 1 is a block diagram illustrating a configuration of a wheel state determination apparatus 100 according to an embodiment.

FIG. 2 is a schematic view for explaining wheels of a vehicle 1.

FIG. 3 is a schematic view for explaining a direction of acceleration detected by an acceleration sensor 20.

FIG. 4 is a schematic view for explaining a determination threshold value of axial acceleration.

FIG. 5 is a flowchart for explaining a wheel separation determination process.

### DESCRIPTION OF EMBODIMENTS

### <Configuration of a Wheel State Determination Apparatus>

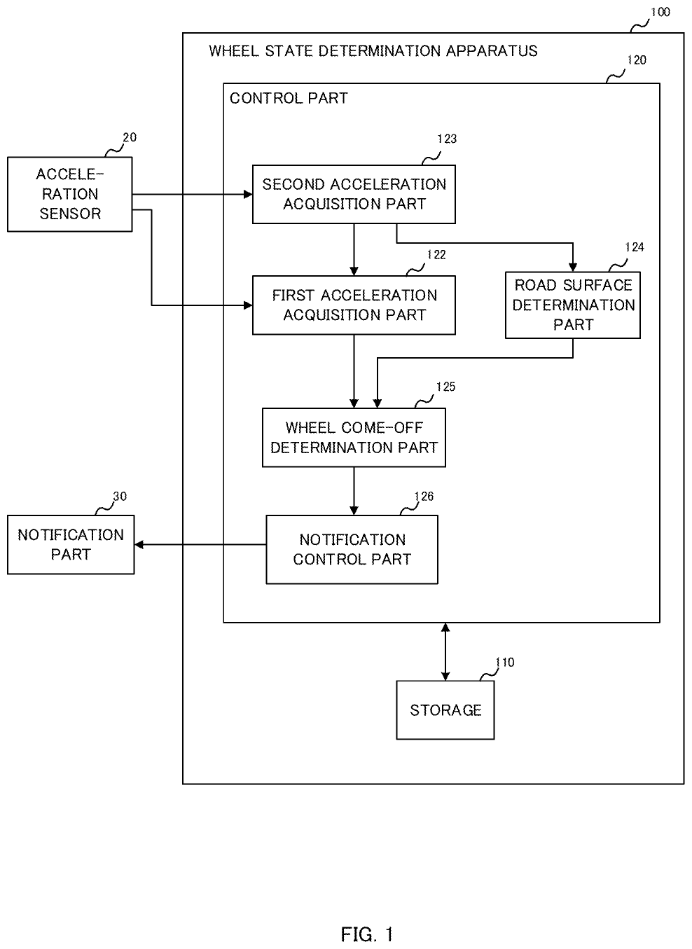

A configuration of a wheel state determination apparatus according to an embodiment of the present invention will be described with reference to FIG. 1.

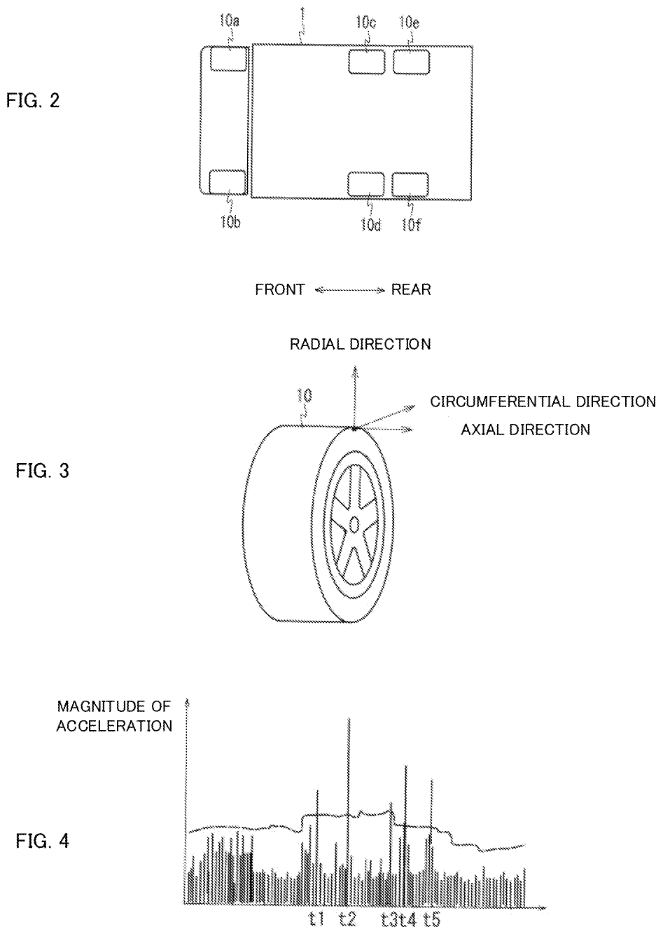

FIG. 1 is a block diagram illustrating a configuration of a wheel state determination apparatus 100 according to an embodiment. The wheel state determination apparatus 100 determines a state of a wheel of a vehicle. For example, the wheel state determination apparatus 100 determines whether or not the wheel is in a state where it may come off. Here, the vehicle is a truck shown in FIG. 2, but is not limited thereto.

FIG. 2 is a schematic view illustrating wheels of the vehicle 1. The vehicle 1 is provided with wheels 10a to 10f. The wheels 10a and 10b are front wheels, the wheels 10c and 10d are first rear wheels, and the wheels 10e and 10f are second rear wheels. The wheels 10a to 10f are fixed to the corresponding axles via bolts and nuts, respectively. Hereinafter, the wheels 10a to 10f are also collectively referred to as wheels 10.

In the vehicle 1, there may be a case where a wheel 10 comes off. When a nut of a wheel member of the wheel 10 is not loosened, there is no possibility that the wheel 10 comes off the axle. However, if the nut is loosened, there is a possibility that the nut becomes further loosened while the vehicle is traveling, causing the wheel 10 to come off the axle. In order to ensure safety during traveling, it is desirable to perform maintenance such as tightening nuts before the wheel 10 comes off.

Thus, although details will be described later, the wheel state determination apparatus 100 of the present embodiment determines whether or not there is a high possibility that the wheel 10 will come off on the basis of the magnitude of axial acceleration acting on the wheel 10, and notifies a driver or the like when the possibility is high. In this way, the driver or the like can grasp that the wheel 10 is in the state where it may come off before the wheel 10 comes off, making it easier to take measures. The axial acceleration is used because it was found that specific axial acceleration occurs when the nut is loosened.

As shown in FIG. 1, the wheel state determination apparatus 100 includes a storage 110 and a control part 120. The storage 110 includes a ROM (Read Only Memory) and a RAM (Random Access Memory), for example. The storage 110 stores various types of data and a program to be executed by the control part 120. For example, the storage 110 stores a determination threshold value used in a wheel separation determination process for the wheel 10.

The control part 120 is a CPU (Central Processing Unit), for example. The control part 120 controls operations of the wheel state determination apparatus 100 by executing the program stored in the storage 110. In the present embodiment, the control part 120 functions as a first acceleration acquisition part 122, a second acceleration acquisition part 123, a road surface determination part 124, a wheel separation determination part 125, and a notification control part 126. In the present embodiment, the first acceleration acquisition part 122 and the second acceleration acquisition part 123 correspond to an acceleration acquisition part.

The first acceleration acquisition part 122 sequentially acquires axial accelerations in an axial direction of the wheel 10. The first acceleration acquisition part 122 sequentially acquires axial accelerations for each of the wheels 10a to 10f shown in FIG. 2. The first acceleration acquisition part 122 sequentially outputs the acquired axial accelerations to the wheel separation determination part 125.

The axial accelerations are detected by the acceleration sensor 20 provided in each of the wheels 10a to 10f, at predetermined intervals. The acceleration sensor 20 is attached to a wheel member of each of the wheels 10a to 10f.

FIG. 3 is a schematic view for explaining a direction of acceleration detected by the acceleration sensor 20. The acceleration sensor 20 can detect circumferential acceleration in a circumferential direction and radial acceleration in a radial direction, in addition to the axial acceleration in the axial direction of the wheel 10. The acceleration sensor 20 sequentially detects the axial acceleration, the circumferential acceleration, and the radial acceleration at predetermined intervals.

The second acceleration acquisition part 123 acquires circumferential acceleration and radial acceleration of the wheel 10. That is, the second acceleration acquisition part 123 acquires the circumferential accelerations and radial accelerations detected by the acceleration sensor 20 at predetermined intervals. The second acceleration acquisition part 123 outputs the acquired circumferential accelerations and radial accelerations to the road surface determination part 124.

The road surface determination part 124 determines a road surface condition of a road surface on which the vehicle 1 travels. For example, the road surface determination part 124 determines whether the surface being traveled on is paved or gravel. That is, the road surface determination part 124 determines the type of the road surface.

The road surface determination part 124 determines the road surface condition on the basis of the circumferential accelerations and the radial accelerations acquired by the second acceleration acquisition part 123. For example, the road surface determination part 124 extracts the vertical oscillation pertaining to the road surface from the circumferential accelerations and the radial accelerations, and determines the type of the road surface on the basis of the extracted vertical oscillation. Specifically, the road surface determination part 124 determines that the road surface is gravel if the magnitude of the vertical oscillation is greater than a predetermined value, and the road surface determination part 124 determines that the road surface is paved if the magnitude of the vertical oscillation is smaller than the predetermined value. The road surface determination part 124 outputs a determination result to the wheel separation determination part 125.

The wheel separation determination part 125 determines whether or not the wheel 10 of the vehicle 1 is in a state where it may come off. For example, the wheel separation determination part 125 determines whether or not any of the wheels 10a to 10f shown in FIG. 2 are in the state where they may come off while the vehicle 1 is traveling.

The wheel separation determination part 125 determines whether or not a wheel 10 is in the state where it may come off by using the axial acceleration acting on the wheel 10. Specifically, in a case where the specific axial acceleration has occurred, the wheel separation determination part 125 determines that the nut of the wheel member of the wheel 10 is loosened, and determines that the wheel 10 is in the state where it may come off.

If the axial acceleration acquired by the first acceleration acquisition part 122 is greater than a predetermined determination threshold value, the wheel separation determination part 125 determines that the possibility of the wheel 10 coming off is high. This makes it possible to detect the state in which the wheel 10 may come off before the wheel 10 comes off. The wheel separation determination part 125 sets, as the determination threshold value, a value obtained by multiplying a moving mean value of the axial accelerations by a predetermined coefficient.

FIG. 4 is a schematic view for explaining the determination threshold value of the axial acceleration. The moving mean value is obtained by plotting the average of the axial accelerations at predetermined time intervals. A broken line in FIG. 4 indicates the value obtained by multiplying the moving mean value by the predetermined coefficient, showing that the magnitude of the moving mean value changes over time. The predetermined coefficient is a coefficient adjusted to facilitate detection of a specific acceleration. Therefore, the determination threshold value also changes over time. In FIG. 4, specific accelerations exceeding the value obtained by multiplying the moving mean value by the predetermined coefficient are observed at timings t1, t2, t3, t4, and t5. The wheel separation determination part 125 determines that the axial acceleration is greater than the determination threshold value at the timings t1 to t5. In the above description, the wheel separation determination part 125 sets the value obtained by multiplying the moving mean value of the axial accelerations by the predetermined coefficient as the determination threshold value, but the embodiment is not limited thereto. For example, the wheel separation determination part 125 may use a value obtained by adding a moving standard deviation to the moving mean value of the axial accelerations, as the determination threshold value. The specific acceleration can also be detected in this case.

If the number of times the acquired axial acceleration exceeds the determination threshold value reaches a predetermined number of times within a predetermined period of time, the wheel separation determination part 125 determines that the possibility of the wheel 10 coming off is high. If the number of times the acquired axial acceleration exceeds the determination threshold value does not reach the predetermined number of times within the predetermined period of time, the wheel separation determination part 125 resets a count. By doing this, even in the event of a sudden occurrence of the axial acceleration exceeding the determination threshold value due to external disturbances or the like, the occurrence of erroneous detection can be prevented because the count does not reach the predetermined number of times.

The wheel separation determination part 125 may change the determination threshold value according to the road surface condition determined by the road surface determination part 124. For example, the wheel separation determination part 125 makes the determination threshold value higher for road surfaces with gravel than for paved road surfaces. In the cases of the road surfaces with gravel, there is a tendency for axial acceleration to increase. Thus, by increasing the determination threshold value, it is possible to prevent the axial acceleration from exceeding the determination threshold value where there is no actual risk of a wheel separation. As a result, the occurrence of erroneous detection can be prevented.

The notification control part 126 controls the notification part 30. For example, when it is determined by the wheel separation determination part 125 that the wheel 10 is in the state where it may come off, the notification control part 126 causes the notification part 30 to provide notification to that effect. The notification part 30 is a display unit that displays information on a screen or a sound output unit that outputs sound, for example. By receiving such notification, the driver of the vehicle 1 can recognize that the wheel 10 is in the state where it may come off if traveling is continued.

### <Wheel Separation Determination Process>

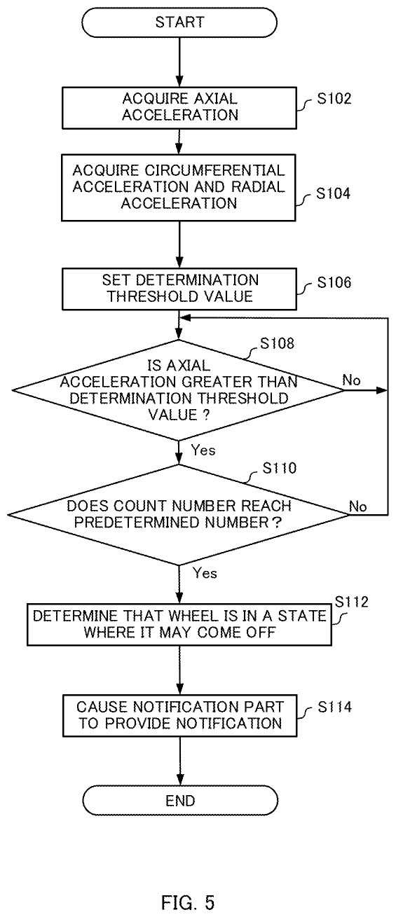

A wheel separation determination process will be described with reference to FIG. 5. FIG. 5 is a flowchart illustrating the wheel separation determination process. The process shown in FIG. 5 is performed while the vehicle 1 is traveling. Here, the wheel separation determination process is performed on the wheel 10f (FIG. 2), and the same process is performed on the other wheels 10a to 10e.

First, a first acceleration acquisition part 122 acquires axial acceleration of the wheel 10f from the acceleration sensor 20 (step S102). A second acceleration acquisition part 123 acquires circumferential acceleration and radial acceleration of the wheel 10f from the acceleration sensor 20 (step S104). The processes of steps S102 and S104 may be performed simultaneously.

Next, the wheel separation determination part 125 sets a determination threshold value corresponding to the road surface condition of a road surface with which the wheel 10f comes into contact (step S106). For example, the wheel separation determination part 125 sets the determination threshold value corresponding to the road surface condition determined by the road surface determination part 124 on the basis of the circumferential acceleration and the radial acceleration.

Next, the wheel separation determination part 125 determines whether or not the axial acceleration acquired by the first acceleration acquisition part 122 is greater than the determination threshold value (step S108). For example, the wheel separation determination part 125 determines whether or not the axial acceleration is greater than the determination threshold value set in step S106.

If it is determined in step S108 that the axial acceleration is greater than the determination threshold value (Yes), the wheel separation determination part 125 determines whether the count number, for the number of times that the axial acceleration has exceeded the determination threshold value, reaches a predetermined number of times within a predetermined time period (step S110). If the count number does not reach the predetermined number of times in step S110 (No), the wheel separation determination part 125 resets the count number.

On the other hand, if the count number reaches the predetermined number of times within the predetermined time period in step S110 (Yes), the wheel separation determination part 125 determines that the wheel 10f is in a state where the wheel 10f may come off (step S112). Next, the notification control part 126 causes the notification part 30 to provide notification that the wheel 10f is in the state where it may come off (step S114).

### Modified Example

In the above description, the wheel separation determination part 125 determines whether or not one wheel 10 is in the state where said one wheel 10 may come off (hereinafter, simply referred to as a wheel separation determination) by using the axial acceleration of the one wheel 10. On the other hand, in Modified Example, the wheel separation determination for one wheel 10 is performed using a mean value of axial accelerations of a plurality of wheels 10 and a standard deviation, as described below.

The first acceleration acquisition part 122 acquires axial accelerations of each of the plurality of wheels 10 (specifically, the wheels 10a to 10f) of the vehicle 1. That is, the first acceleration acquisition part 122 also acquires the axial accelerations of wheels other than the wheel for which the determination is to be made.

The wheel separation determination part 125 performs the wheel separation determination on the basis of whether or not the axial acceleration of one wheel 10 to for which the determination is to be made is within a range indicated by the mean value of the axial accelerations of the plurality of wheels 10 acquired by the first acceleration acquisition part 122 and σ, which is the standard deviation. Assuming that the axial acceleration follows a normal distribution, when the axial acceleration is within the range indicated by the mean value of the axial acceleration±1σ, there is no risk of wheel separation. However, when the axial acceleration is outside the range indicated by the mean value±1σ, there is a risk of wheel separation. The standard deviation may be 20 or 30. For example, when the axial acceleration of the wheel 10f is outside a range indicated by the mean value of the axial accelerations of the wheels 10a to 10f±the standard deviation, the wheel separation determination part 125 determines that the wheel 10f is in the state where it may come off. The wheel separation determination part 125 performs similar determination processes on the wheels 10b to 10f.

According to Modified Example, by identifying a wheel 10 whose axial acceleration is abnormal, from among the plurality of wheels 10, it is possible to detect the wheel 10 in the state where it may come off.

In the above description, the wheel separation determination for one wheel is performed using the mean value of the axial accelerations of all of the wheels 10a to 10f and the standard deviation, but the present invention is not limited thereto. For example, the wheel separation determination for any one of the wheels 10c to 10f may be performed using the mean value of the axial accelerations of the wheels 10c to 10f, which are the rear wheels, and the standard deviation. Similarly, by using the mean value of the axial accelerations of the wheels 10a and 10b and the standard deviation, the wheel separation determination for one of the wheels 10a and 10b may be performed. Since the behavior differs between the front and rear wheels, by using the mean value of axial accelerations among wheels that are likely to exhibit the same behavior and the standard deviation, it is possible to accurately detect the state where the wheel may come off.

### Effect of the Present Embodiment

The wheel state determination apparatus 100 of the embodiment described above acquires the axial acceleration of the wheel 10, and determines that the possibility of the wheel 10 coming off is high if the acquired axial acceleration is greater than the determination threshold value. As a result, it is possible to detect that the wheel 10 is in the state where it may come off before the wheel 10 comes off. Therefore, it becomes easy to take measures before the wheel 10 comes off, and safety during traveling can be ensured.

The present disclosure is explained based on the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

### DESCRIPTION OF SYMBOLS

1 Vehicle
10 Wheel
20 Acceleration sensor
100 Wheel state determination apparatus
122 First acceleration acquisition part
123 Second acceleration acquisition part
124 Road surface determination part
125 Wheel separation determination part

1. A wheel state determination apparatus comprising:
an acceleration acquisition part that sequentially acquires axial accelerations in an axial direction of a wheel, the axial accelerations being detected at predetermined intervals by an acceleration sensor provided in the wheel of a vehicle; and
a wheel separation determination part that determines that a possibility of the wheel coming off is high if the axial acceleration acquired by the acceleration acquisition part is greater than a predetermined determination threshold value.

2. The wheel state determination apparatus according to claim 1, wherein the wheel separation determination part determines that the possibility of the wheel coming off is high, if the number of times the acquired axial acceleration exceeds the determination threshold value reaches a predetermined number of times within a predetermined time.

3. The wheel state determination apparatus according to claim 1, further comprising:
a road surface determination part that determines a road surface condition of a road surface on which the vehicle travels, wherein
the wheel separation determination part changes the determination threshold value according to the road surface condition determined by the road surface determination part.

4. The wheel state determination apparatus according to claim 3, wherein the acceleration acquisition part further acquires circumferential acceleration in a circumferential direction of the wheel and radial acceleration in a radial direction of the wheel, and the road surface determination part determines the road surface condition on the basis of the circumferential acceleration and the radial acceleration acquired by the acceleration acquisition part.

5. The wheel state determination apparatus according to claim 4, wherein the road surface determination part extracts vertical oscillation pertaining to the road surface from the circumferential acceleration and the radial acceleration acquired by the acceleration acquisition part, and determines a type of the road surface on the basis of the vertical oscillation.

6. The wheel state determination apparatus according to claim 5, wherein the road surface determination part determines that the road surface is gravel if the magnitude of the vertical oscillation is greater than a predetermined value, and determines that the road surface is paved if the magnitude of the vertical oscillation is smaller than the predetermined value.

7. The wheel state determination apparatus according to claim 1, wherein
the wheel separation determination part sets, as the determination threshold value, a value obtained by multiplying a moving mean value of the axial accelerations by a predetermined coefficient.

8. The wheel state determination apparatus according to claim 1, wherein
the wheel separation determination part sets, as the determination threshold value, a value obtained by adding a moving standard deviation to a moving mean value of the axial accelerations.

9. The wheel state determination apparatus according to claim 1, wherein
the acceleration acquisition part acquires the axial accelerations of each of a plurality of wheels of the vehicle, and
the wheel separation determination part determines that a possibility of one wheel coming off is high when axial acceleration of the one wheel is outside a range indicated by a mean value of the axial accelerations of the plurality of wheels and a standard deviation.
